(19) United States
(12) Patent Application Publication
(10) Pub. No.: US 2004/0083819 A1
(43) Pub. Date: May 6, 2004

(54) Method and apparatus for testing the rolling tack of pressure-sensitive adhesives

(75) Inventors: Amos Nussinovitch, Rehovot (IL); Omri Ben-Zion, Ramat Hasharon (IL)

Correspondence Address: BROWDY AND NEIMARK, P.L.L.C., 624 Ninth Street, N.W., Washington, DC, 20001, US

(73) Assignee: Yissum Research Development Company of the Hebrew University of Jerusalem, Jerusalem (IL)

(21) Appl. No.: 10/400,070

(22) Filed: Mar. 27, 2003

Related U.S. Application Data
(60) Provisional application No. 60/367,484, filed on Mar. 27, 2002.

(51) Int. Cl. G01N 3/08

(52) U.S. Cl. 73/818

(57) ABSTRACT

A method and apparatus for testing tack of Pressure Sensitive Adhesives (PSA) and other sticky materials is disclosed to simplify the measurement of bonding and debonding procedures. A modified rolling tack test is applied using a device attached on to an Instron Universal Testing machine. By predetermining the angle (position) of a cylindrical probe-roller hanging down to the Instron's cross-head and leaning parallel to a rotary drum covered with tacky substance, the pressure of the probe and its rolling velocity (as an expression for dwell time) can be controlled independently. The ease of execution and its high reproducibility enable the use of the new method to study the experimental tack of adhesive materials.

### CROSS REFERENCE TO RELATED APPLICATIONS

This application claims the benefit of U.S. provisional application No. 60/367,484, filed Mar. 27, 2002, the contents of which are entirely Incorporated by reference herein.

### FIELD OF INVENTION

The present invention relates generally to an apparatus for providing a measure of tack employing an Instron Universal Testing Machine.

### OBJECTS AND SUMMARY OF THE INVENTION

It is therefore an object of the present invention to provide an apparatus and method for monitoring accurate, quantitative tack measurement of PSA materials, using a simultaneous controlled method for applying constant pressure and dwell time (period of bond formation). It is still another object of the present invention to provide relatively simple and inexpensive device to manufacture. The resulting tack measurement can be used as a standard method for control variable in product development or quality assurance. These objects will become apparent from the following detailed description.

### BACKGROUND OF THE INVENTION

Tackiness of pressure-sensitive adhesives (PSA) materials is an essential property to be considered when preformulating applications such as: adhesive tapes (for hospital and first aid, packaging, automotive, pipeline coatings, graphic arts, labels, etc.); moisture-activated products (stamps, cigarette papers, decals etc.); medical (dressings, bioelectrodes, ostomies, trnsdermal delivery systems); dental (dentures); laminated foods and dough; wall papers; paint and inks; cosmetics (creams, lotions, sprays etc.); tanning; carpentry; and the like. Pressure-sensitive tack is the adhesive property related to bond formation; It is the property which enables the adhesive to form a bond with the surface of another material upon brief contact under light pressure (Satas, 1982). Insufficient tack may shorten the duration of the PSA attachment to its adherent while excessive tack may cause useless repositioning skills, skin irritations or generally leave adhesive residues when the PSA is removed. There are three main methods to determine the tack of Pressure-Sensitive Adhesives (PSA) (Johnston, 1983), namely, ‘rolling ball’, ‘probe-tack’ and ‘rolling cylinder’ tests. Other methods include the ‘modified peel’ and ‘loop-tack’ tests (Johnston, 1984). In the rolling ball tack test, a ball is rolled down an inclined plane onto a film of a PSA and the tack value is proportional to the reciprocal of the distance rolled. Since the velocity of the ball changes at every moment and at the same time the tack varies as a function of velocity, only the contact pressure can be controlled as per the weight of the ball used. This method of expressing tack is useful in some practical cases, but the physical meaning of the values is not necessarily clear. In the probe tack test, the butt tensile strength of the bond formed between the tip of the probe and the adhesive after a short time at low pressure is taken as the tack level. Here, although theoretically both contact pressure, dwell time and debonding velocity can be simultaneously predetermined, such apparatus is very complicated and costly. It is also limited to some extent with regards to contact time and pressure. Alternatively, the puling cylinder method has been previously developed (Mizumachi 1985; Mizumachi and Hatano 1989) in order to understand tack on scientific bases. If a force to pull a cylinder on a PSA at constant velocity is measured, one can calculate its rolling friction coefficient, f, which depends upon the physical properties of the tested materials, and not upon any trivial experimental parameters. With the puling cylinder method, f of the material is given by the following simple equation: f=PR/Mg, where P is the force to pull a cylinder of radius R and weight Mg at a constant velocity v. R and Mg can be varied independently in order to change contact pressure. When the cylinder is pulled upon the PSA, the rolling motion reflects tackiness by which bonding and debonding process proceed simultaneously within the surface of contact. However, the use of a cylindrical assembly device limits its use when a very low contact pressure is required, namely, in the order of 1 gr/cm² or less. Very low contact pressure is sufficient, in most PSA's, for initial bond formation. This critical situation is highly depended upon the viscoelasticity of the PSA and surface adherent properties (Mitzumachi, 1985, Ben-Zion et al., 1999). Table 1. Summarize the aforementioned tack testing methods with regards to their features.

TABLE 1

| | Controlled dwell- | Controlled | |
|---|---|---|---|
| T st method | time | pressure | Remark |
| rolling ball | no | yes | Limited pressure |
| probe-tack | yes | yes | Limited pressure |
| | | | Limited dwell time |
| rolling cylinder | yes | yes | Limited pressure |
| modified peel | no | no | |
| loop-tack tests | no | no | |

Off all methods, the pulling cylinder test is an outstanding choice for measuring tack of any PSA material. In order to test the simultaneous effects of both bonding procedure and contact pressure a novel apparatus is disclosed, namely, a modified improved rolling cylinder device. Experiments were carried out to determine the initial skin-tack properties of tacky materials.

### DETAILED DESCRIPTION OF THE INVENTION

FIGS. 1A-D represents the assembly device. A cylindrical probe-roller (1) (diameter: 3 cm, weight 100 gr.) is coated with a flexible test substrate, by means of double-faced adhesive tape (Catalina Graphic Films, CA, USA). The cylindrical roller (1) spins freely by means of vertical axial bearings (2 and 3, respectively). Said roller is attached to a balancing supporting frame (4), centrally mounted to a thin metal wire (5) via micro grip, hanged down to a cross head (6) of an Instron Universal Testing Machine (model #1011, MA, USA) (7). Thereunder, a mini-roller (8) is coupled to the cross head by means of supporting device (9), conjucted with adjustable rod (10) to maintain uniaxially position of the wire and transducer (11). The probe-roller assembly is leaned parallel to a rotary drum (12) (diameter 5 cm) coated with the tested pressure sensitive adhesive substance. The drum is connected to rotational motor (13) (24 VDC, 70W), controlled by encoder (HP, HEDS5500) and velocity gauge (SAIA, CXG 211) via propelling force transmission (14) (short term moment: 3 N×m). Controlling the motor voltage enables to provide a rolling velocity of up to 1100 RPM (equal to ˜2.8 m/s, given a 5 cm diameter drum). When the drum (12) circulates, the probe-roller (1) spins and the adhesive frictional force is recorded via the Instron's transducer (11). The rotary drum (12) is fixed to a base (15), attached on to the Instron's floor via screwing joint (16), and is vertically shiftable with intervals steps (17) or interconnected micrometer (18) in response to selective movement towards the hanged probe-roller (1). The later being shifted accordingly, thus, the angle of the hanged roller-probe could be adjusted relatively to the center of the Instron's cross head. By applying a simple trigonometric calculation (FIG. 2) one can achieve an acting load down to an order of 0.005 gr., given an angle (α) of 6.66×10⁻⁵ radians, probe weight of 100 gr., and grip distance of 10 cm. Although, theoretically, it is feasible to set extremely small angles, using said apparatus, it is worth noting that in practical use most PSA's features initial bond formation when greater loads are applied, still not detectable with aforementioned tack testing methods.

Thereof, said apparatus is capable of controlling the pressure of the probe and its rolling velocity independently. Rolling velocity is an expression for dwell time. It is well known that rolling velocity and tack (expressed as tack energy or rolling friction) are somewhat proportional to each other. Tack becomes very low when the velocity of the rolling cylinder becomes extremely low or extremely high. Then, if we plot the values of tack vs. velocity, it would be possible to obtain a curve, having a certain maximum. The simultaneous effect of contact pressure and dwell time will become apparent from the following detailed examples.

Testing PSA tapes, labels, decals or any other surface coated adhesive is easily applied by rolling a rectangle-shaped sample of a known width on top of the drum (12) using double-faced adhesive strip. This type of testing is most appropriate for quality control measurements and ready to use PSA products. Application of a tailor-maid device (FIG. 1d) makes possible to create a uniformly coated PSA for testing tack properties in the preformulation stage. The assembly comprises of a cylindrical Plexiglas (19), coated by disposable polyvinyl release-film on its interior wall. Another cylinder (20) (diameter: 5 cm) is concentrically positioned through the interior of the later cylinder (19), mounted on a rigid metal base (21) and leaving 2 mm space in between. A cover (22) is positioned on top of the assembly, permitting three depositing apertures (23) on top of the space, thus enabling to pour therethrough a PSA solution (24) in order to set and directly coat the inside cylinder. After a complete setting of the PSA, the release film is removed along with the outer cylinder while the coated cylinder is ready for positioning towards the drum (12) by using screw holders for securely supporting the tested sample.

Provision of a heavy-duty, coupled bearing devices, accurately molded PSA samples and uniaxial settings, essentially eliminates the potentially interfering factor of probe shivering and moving aberrations. Given accuration and high pressure-velocity resolution, said apparatus is capable of providing operably meaningful tack data, not feasible by other tack testing methods.

### DRAWING DESCRIPTIONS

FIG. 1A is a vertical sectional view of a commercially available Instron Universal Testing Machine, shown in conjunction with a rolling tack apparatus in accordance with the invention.

FIG. 1B is a fragmentary, side view, illustrating the rolling assembly devices mounted to a shiftable base.

FIG. 1C is a top plan view, similar to that of FIG. 1B, and depicting the motor assambley.

FIG. 1D (top) is a vertical sectional view of concentric sample preparation device, illustrating use thereof with a test sample of PSA loaded therein. (bottom) is a top sectional plan view of the lid.

### Components:

1. Cylindrical probe-roller

2. axel

3. bearing

4. supportive frame

5. metal wire

6. cross-head

7. Instron Universal Testing Machine

8. mini-roller

9. supporting device

10. adjustable rod

11. transducer

12. rotary drum

13. motor

14. propelling force transmission

15. base

16. screwing joint

17. shifting intervals

18. micrometer

19. outer cylinder coated with release film

20. inner cylinder

21. concentric base

22. top cover

23. depositing apertures

24. PSA solution

### EXAMPLE

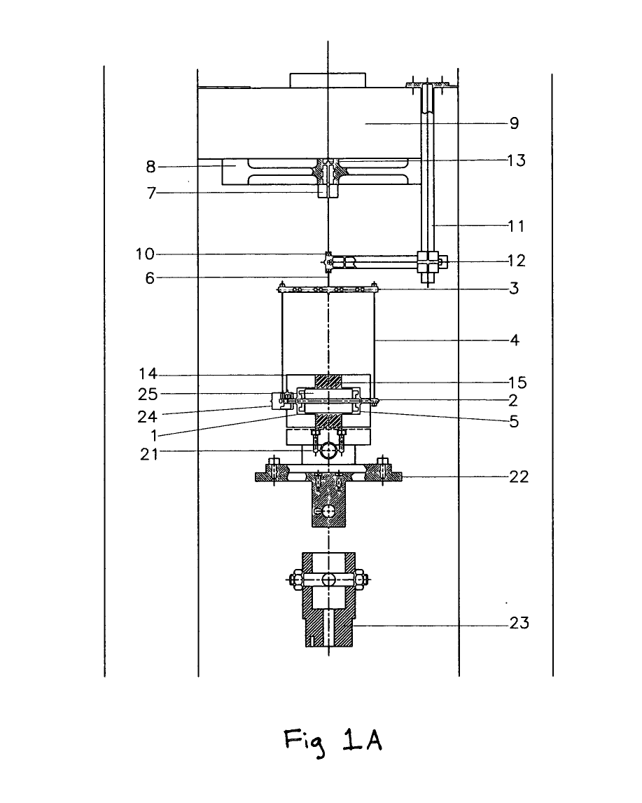

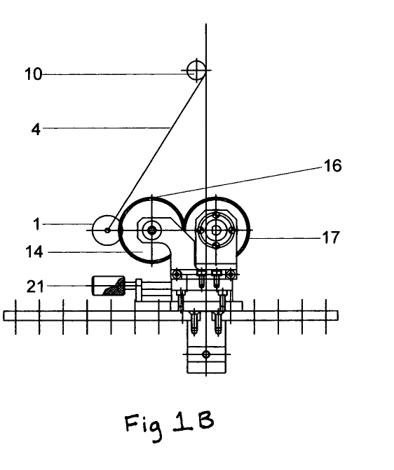

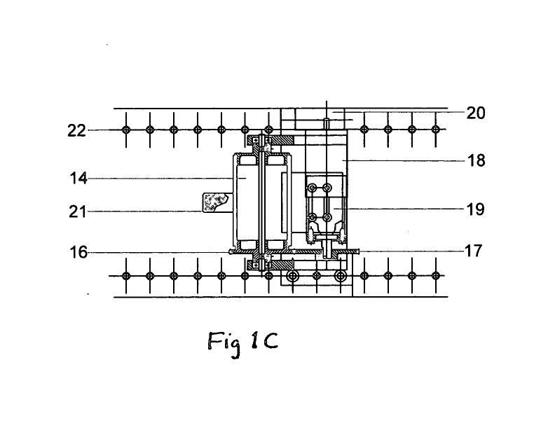

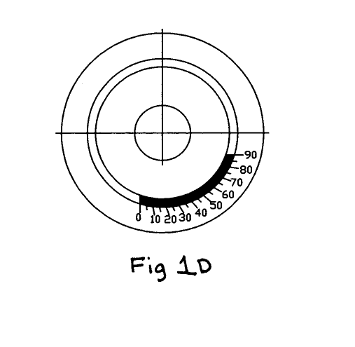

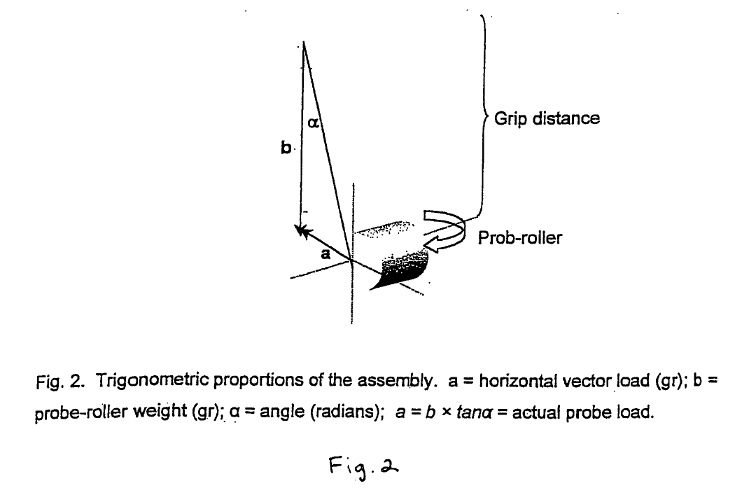

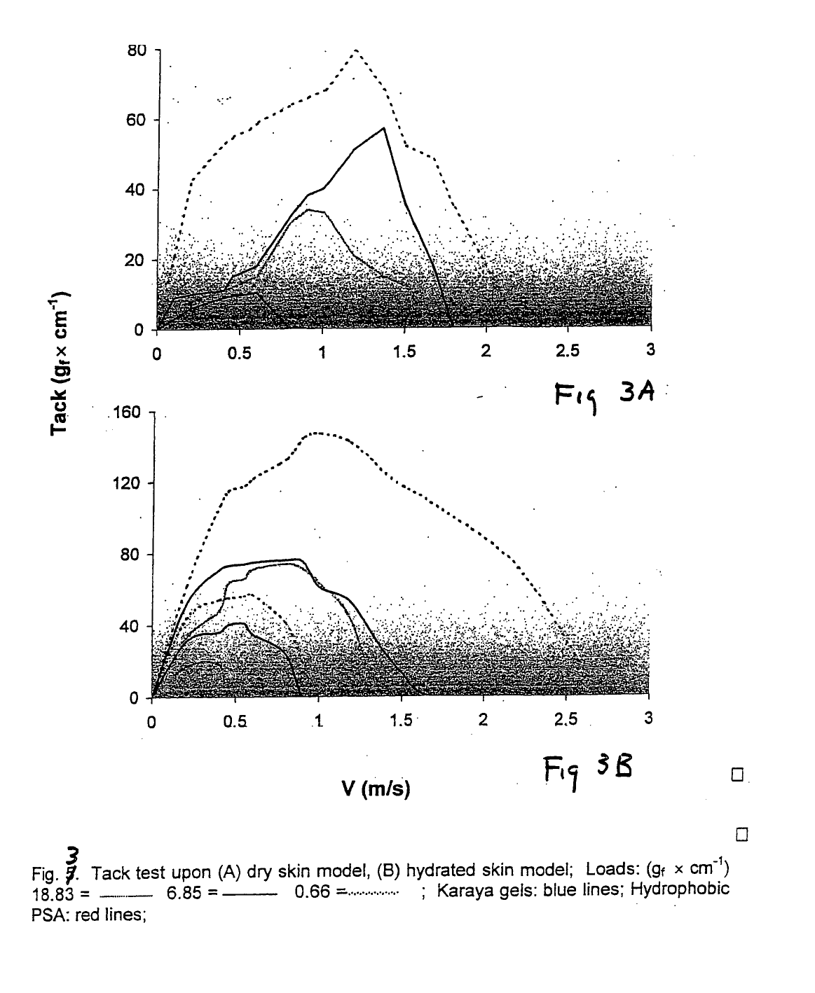

Two samples were tested to demonstrate the validity of said apparatus, namely, karaya gum sticky gels (Nussinovitch, 1997) and commercial low-tack first aid PSA. Karaya gels were prepared utilizing molded device (FIG. 1D) while first-aid tape, hereinafter, hydrophobic PSA, was coupled to the rotary drum via double faced adhesive removable tape. Probe-roller was coated with a skin-like model according to previously described method (Charkoudian, 1989) and hydrated by submerging it in double distilled water, followed by true blotting. Dry skin model had ˜2% moisture compared to 40% after hydration. Samples were prepared in two batches, of which two determinations have been used.

To test the simultaneous effect of the probe pressure and dwell time, the angle of the hanged roller and rotary-drum velocity were varied, respectively. 3 different angles were fixed, namely, 0.034, 0.35 and 0.78 radians, provided acting loads of 0.66, 6.85 and 18.83 gr_{f}×cm⁻¹, respectively. Velocity was carried out in small intervals from zero to ˜2.7 m/s (corresponding to RPM). All measurements were performed at room temperature.

FIGS. 3A and 3B represents the measured averaged tack vs. rolling velocity for karaya gel and low-tack hydrophobic PSA tested on dry and hydrated skin-like model, respectively. Assuming the contact surface between the roller and drum is non-deformable (within the range of applied stress), the indication of pressure could be successfully expressed as force per width unit. It is clearly shown that the bonding process has a remarkable influence upon the shape of the curve of tack vs. v. In some point the curves goes through a maximum and tends down until the final measured tack is ˜zero. That means that if velocity of the rolling cylinder is extremely high, debonding occurs before the efficient contact of the adhesive and substrate is realized. Generally, karaya gels showed relatively higher tack values compared to low-tack hydrophobic PSA at any given velocity. When tested upon hydrated skin model, both adhesives lost tack with comparison to a dry skin model. Low-tack PSA lost 78-85% of its tack while karaya gel lost only 46-58% (calculated according to the pick values). The PSA, being an hydrophobic material do not favors the surrounding of water, therefore lost its adhesiveity upon hydration. Contrariwise, karaya gels are capable of water absorbing to some extent (until the formation-of a slippery mucilage). The effect of pressure sensitivity (increased load) was clearly pronounced for both karaya gel and hydrophobic PSA. In both cases, increasing the load resulted in a higher measured tack values at any given velocity. Increasing the velocity, resulted in a general shift of decreased portions of the curves toward higher velocities for higher loads. In other words, increasing pressure upon the adhesive compensates for a short-term bonding, in which wetting procedure can not proceed completely. Given that the minimum applied load (less then one gr×cm⁻¹ by fixing an angle of ˜0.35 radians) was sufficient to achieve meaningful tack values, we can conclude the necessity of pressure-control when testing bond formation of tacky materials. Our novel apparatus, capable of controlling the pressure applied when testing tack of PSA is an outstanding important tool in analyzing the mechanism of bond formation and can be used in many other applications such as tapes for packaging and automotive, wall papers, pipeline coatings, graphic arts, lables, moistute activated adhesives (stamps, cigarette papers, decals etc.), doughs, food coatings, paints, inks arid the like.

FIG. 4 is a perspective view of th apparatus; FIG. 5 shows parts of said apparatus in perspective; and FIG. 6 is a duplicate of FIG. 1A without reference numerals.

Included as part of this disclosure and made a part hereof are the following four (4) publications:

(1) O. Ben-Zion and A. Nussinovitch; “Testing the Rolling Tack of Pressure-sensitive Adhesive Materials. Part 1. Novel Method and Apparatus. J. Adhesion Sci. Technol. Vol. No. 16, No. 3, pp. 227-237 (2002):

(2) O. Ben-Zion and A. Nussinovitch; “Testing the Rolling Tack of Pressure-sensitive Adhesive Materials. Part 11. Effect of Adhered Surface Roughness. J. Adhesion Sci. Technol. Vol. No. 16, No. 5, pp. 597-617 (2002):

(3) O. Ben-Zion, Mark Karpasas and A. Nussinovitch; “Determination of Green-Bond Strength in Tacky Poly(vinyl alcohol) Hydrogels. Journal of Applied Polymer Science, Vol. 87, 2130-2135 (2003): and

(4): O. Ben-Zion and A. Nussinovitch; “Innovative Rolling Tack and Skin Model for Adhesion-to-Skin Testing. The Hebrew University of Israel, Institute of Biochemistry, Food Science and Human Nutrition, Faculty of Agricultural, Food and Environmental Quality Sciences.

A complete copy of the first of these is attached, along with Abstracts of the second, third and fourth of these publications.

The foregoing description of the specific embodiments will so fully reveal the general nature of the invention that others can, by applying current knowledge, readily modify and/or adapt for various applications such specific embodiments without undue experimentation and without d parting from th generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

Thus, the expressions “means to . . . ” and “means for . . . ”, or any method step language, as may be found in the specification above and/or in the claims below, followed by a functional statement, are intended to define and cover whatever structural, physical, chemical or electrical element or structure, or whatever method step, which may now or in the future exist which carries out the recited function, whether or not precisely equivalent to the embodiment or embodiments disclosed in the specification above, i.e., other means or steps for carrying out the same functions can be used; and it is intended that such expressions be given their broadest interpretation.

### BIBLIOGRAPHY

Ben-Zion O, Nussinovitch A Physical properties of hydrocolloid wet glues. Food Hydrocolloids 1997a; 11, 429-442.

Ben-Zion O, Nussinovitch A. Pressure Sensitive Adhesive Properties of Karaya Gels. The Tenth International Conference and Industrial Exhibition on Gums and Stabilizers for the Food Industry, July 1999, Wells, United Kingdom. Book of abstracts: 90.

Charkoudian JC. Model human skin. U.S. Pat. No. 4,877,454; 1989.

Johnston J. Tack, Proc. Pressure sensitive tape council technical seminar, 1983: 126-146

Johnston J. Physical testing of pressure sensitive adhesive systems. In: Pizzi A, edd. Handbook of adhesive technology. NY: Marcel Dekker Inc, 1994: 549-564.

Mizumachi H. Theory of tack of Pressure-Sensitive Adhesive. I. Journal of Applied Polymer Science 1985; 30: 2675-2686

Mizumachi H. Hatano Y. Theory of tack of Pressure-Sensitive Adhesive. II. Journal of Applied Polymer Science 1989; 37: 3097-3104

Nussinovitch A. Hydrocolloid applications. Gum technology in the food and other industries. London: Blackie Academic & Professional, 1997: 134-136.

Satas D. Handbook of pressure-sensitive adhesive technology. N.Y: Van, Nostrand Reinhold Co, 1982.

What is claimed is:

1. In a method for t sting bond formation of a pressure sensitive adhesive comprising testing for rolling tack, the improvement comprising using a simultaneously controlled method for applying constant pressure and dwell time.

2. An apparatus for carrying out the method of claim 1.

3. A system for testing the rolling tack of pressure sensitive adhesives, as shown and described.
